(19) United States
(12) Patent Application Publication
(10) Pub. No.: US 2006/0004309 A1
(43) Pub. Date: Jan. 5, 2006

(54) Massaging device capable of improving functions of prostate gland

(76) Inventor: Joe Chen, Ta Li City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/880,739

(22) Filed: Jul. 1, 2004

(51) Int. Cl. A61H 15/00

(52) U.S. Cl. 601/115; 601/118; 601/112

(57) ABSTRACT

A massaging device capable of improving functions of prostate gland, including a support member having a supporting face for a human body to sit or ride thereon. A massaging unit having at least one massaging member is disposed in the support member. The massaging unit is driven by a power source to intermittently protrude the massaging member from a surface of the supporting face of the support member so as to massage the perineum of the human body corresponding to the prostate gland.

### BACKGROUND OF THE INVENTION

The present invention is related to a massaging device capable of improving functions of prostate gland. The massaging device includes at least one massaging member powered by a power source for intermittently massaging the perineum of a human body so as to help in caring for the prostate gland.

The prostate gland is an exclusive gland of a male. The prostate gland is located in front of the rectum under the bladder. The prostate gland is formed of two glandules around upper end of the urethra. After ejaculation, the prostate gland secretes prostate gland juice to liquidize the sperms as a component of the semen. The prostate gland juice can protect and culture the sperms and prevent the sperms from being destroyed when passing through the vagina.

The prostate gland is an important gland of male reproduction system and the prostate gland juice is an important component of the semen for culturing and the sperms and expediting fertilization of the egg. In the case that the prostate gland has something wrong, the urination will be obstructed and the sexual life will be greatly affected. The problem of benign hypertrophy of prostate gland often takes place to a male over forty. This is mainly caused by the increment of the prostate gland tissue around the urethra. The swelling prostate gland will compress and narrow the urethra. In order to make the ejected urine pass through the narrowed urethra, the bladder must work harder. As a result, the wall of the bladder will be thickened and become more sensitive. Therefore, the bladder is subject to stimulation. Even little urine is in the bladder, the bladder will more frequently contract. This leads to the problem of polyuria. Eventually, the bladder will fail to fully eject the urine and the urine will remain in the bladder to cause infection, calculus or even kidney failure and uremia.

It can be known from the above that the health of the prostate gland is quite important to a male. Therefore, it is necessary to prevent hypertrophy of prostate gland. The care for the prostate gland has become more and more important recently. Medically, three items are suggested for caring for the prostate gland as follows:
1. Keeping clean: The scrotum of a male has a great extensibility and will secrete much sweat. Moreover, the private parts of a male are often poorly ventilated. Therefore, the private parts are often contaminated and are subject to attack of bacteria. This often leads to prostatitis, hypertrophy of prostate gland and declination of sexual function. Therefore, it is important to frequently clean and wash the perineum for caring for the prostate gland.
2. Avoiding catching cold: In cold day, it should be noted to keep warm and avoid catching cold and infection of upper respiratory pipe. Anyone should not sit on a cold stone, etc. too long. This is because the coldness will excite the sympathetic nerve and thus increase the internal pressure of the urethra to lead to backflow.
3. Massaging: A male can massage himself before sleeping so as to care for himself. The massaging manner is as follows: A male lies with his face up and left leg straight. The left hand is placed on the navel with the middle finger, index-finger and ring finger revolving. At the same time, the three fingers of the right hand are placed on the perineum to revolve and massage the perineum. The perineum is a vital point communicating with governing vessel meridian and conception vessel meridian. Therefore, by means of massaging, the blood circulation of the perineum will be expedited so as to achieve antiphlogistic, painkilling and repelling effects.

Among the above caring measures, the massaging is a most effective measure. Especially, a male can care for his own prostate gland by means of massaging the perineum. Moreover, by means of massaging the perineum, a male's sexual function can be enhanced and the problems of impotence and emission can be improved. The perineum is located between the sexual organs and the anus. A male can massage his own perineum only in a fixed attitude. It is hard to lastingly apply a force onto the perineum. Also, it is inconvenient to ask any other to help in massaging the perineum. Therefore, it is tried by the applicant to develop a massaging device which can massage a user's perineum to improve the functions of prostate gland.

### SUMMARY OF THE INVENTION

It is therefore a primary object of the present invention to provide a massaging device capable of improving functions of prostate gland. The massaging device includes a support member having a supporting face for a human body to sit or ride thereon. A massaging unit has at least one massaging member. The massaging unit is driven by a power source to intermittently protrude the massaging member from a surface of the supporting face of the support member so as to massage the perineum of the human body corresponding to the prostate gland.

The user can sit on the support member, whereby the human body can be massaged in a most comfortable attitude. Moreover, the massaging members of the massaging unit can massage the perineum with a suitable force by way of power. Therefore, it is convenient to massage the perineum and the massaging force is unified.

It is still a further object of the present invention to provide the above massaging device in which the massaging members of the massaging unit take turns to intermittently protrude from the supporting member to intermittently massage the perineum. Therefore, a true massaging effect can be achieved.

It is still a further object of the present invention to provide the above massaging device in which the massaging members are rotary soft wheels. Therefore, the massaging members can massage the perineum with a most suitable force without greatly stimulating the perineum.

It is still a further object of the present invention to provide the above massaging device in which the user can adjust the massaging force of the massaging members to an optimal value according to the sensitivity of the user to the application force.

The present invention can be best understood through the following description and accompanying drawings wherein:

### BRIEF DESCRIPTION OF THE DRAWINGS

FIG. 1 is a perspective view of a first embodiment of the present invention;

FIG. 2 is a perspective view of a part of the first embodiment of the present invention;

FIG. 3 is a top view of a part of the first embodiment of the present invention;

FIG. 4 is a partially sectional view of the first embodiment of the present invention;

FIG. 5 is a side view showing the use of the first embodiment of the present invention;

FIG. 6 is a perspective view of a second embodiment of the present invention;

FIG. 7 is a perspective view of the second embodiment of the present invention, showing that the massaging unit is mounted under a chair;

FIG. 8 is a partially of the second embodiment of the present invention, showing the operation thereof; and

FIG. 9 is a partially sectional view showing the adjustment of the second embodiment of the present invention.

### DETAILED DESCRIPTION OF THE PREFERRED EMBODIMENTS

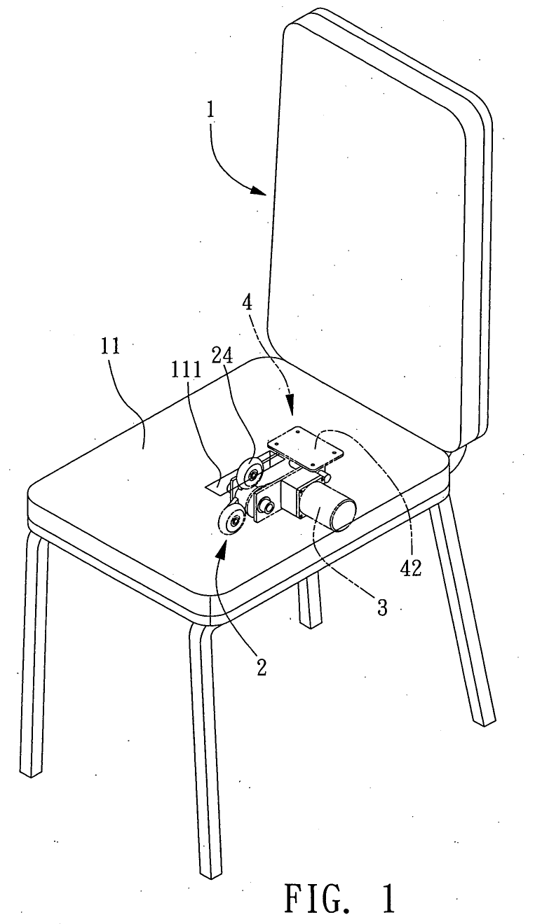

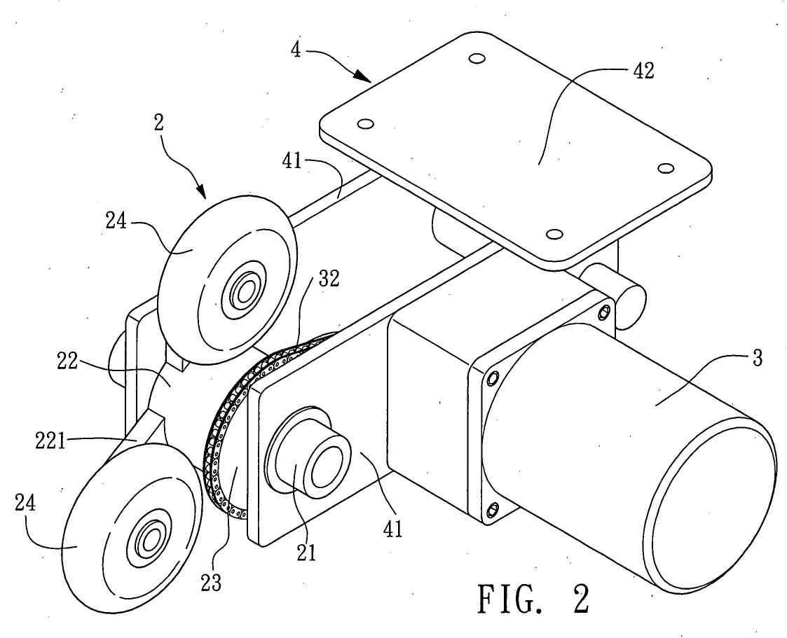

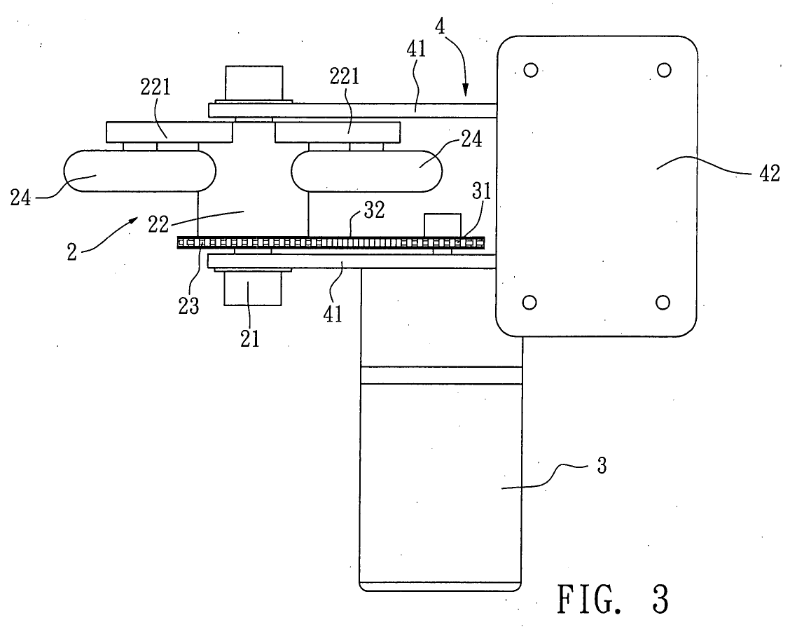

Please refer to FIGS. 1 to 3. According to a first embodiment of the present invention, the massaging device capable of improving the functions of prostate gland includes a support member 1 having a supporting face 11 for a human body to sit or ride thereon. In this embodiment, the support member 1 is a chair and the supporting face 11 is a seat of the chair. A massaging unit 2 is disposed in the support member 1 and driven by a power source 3. The massaging unit 2 intermittently massages the perineum of the human body corresponding to the prostate gland.

In the first embodiment of the present invention, the massaging unit 2 and the power source 3 are fixed under the supporting face 11 via a base seat 4. The base seat 4 has two sidewalls 41 and a fixing plate 42 on upper edges of two first ends of the sidewalls 41. The fixing plate 42 is fixed under the supporting face 11 of the support member 2. The power source 3 is disposed one side of one of the sidewalls 41. In this embodiment, the power source 3 is reducing motor for driving a driving wheel 31 positioned between the two sidewalls 41. The driving wheel 31 is connected with a transmission member 32 for driving the massaging unit 2 to rotate.

The massaging unit 2 is positioned between two second ends of the sidewalls 41 of the base seat 4 opposite to the fixing plate 42. The massaging unit 2 includes a shaft rod 21 two ends of which are shafted on the sidewalls 41. A rotary member 22 and a driven wheel 23 are fitted on the shaft rod 21. The driven wheel 23 is connected with the transmission member 32 of the power source 3. The rotary member 22 has three vanes 221 which radially extend at equal angular intervals. Each vane 221 is pivotally connected with a massaging member 24 which protrudes from the surface of the supporting face 11 of the support member 1. In this embodiment, the massaging member 24 is a soft wheel body.

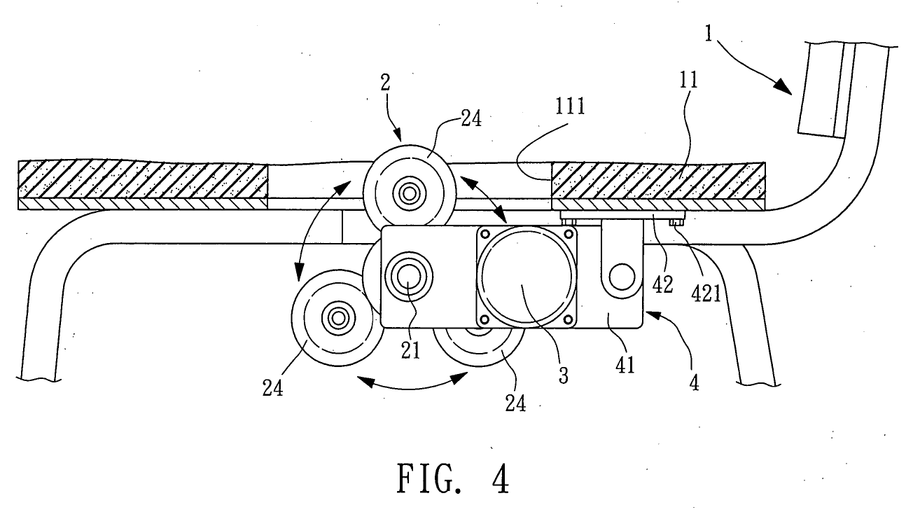

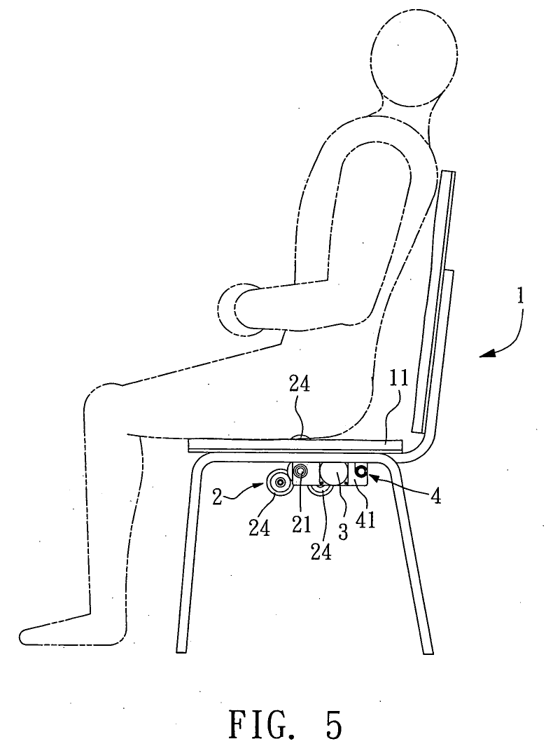

In use, as shown in FIGS. 4 and 5, the fixing plate 42 of the base seat 4 is fixed under the supporting face 11 by screws 421. The supporting face 11 is formed with an opening 111 corresponding to the massaging unit 2. The massaging members 24 of the massaging unit 2 protrude from the opening 111. Accordingly, when a user sits on the supporting face 11 of the support member 1, the user can place his perineum at the opening 111 as shown in FIG. 5. Then the power source 3 is activated to rotate the driving wheel 31. Via the transmission member 32, the driven wheel 23 of the massaging unit 2 is driven to drive and rotate the rotary member 22. Accordingly, the massaging members 24 are sequentially rotated to protrude from the opening 111 so as to intermittently massage the perineum of the user and care for the prostate gland of the user.

According to the above arrangement, the user can sit on the support member 1, whereby the human body can be massaged in a most comfortable attitude. Moreover, the massaging members 24 of the massaging unit 2 can massage the perineum with a suitable force by way of power. Therefore, it is convenient to massage the perineum and the massaging force is unified.

Furthermore, the three massaging members 24 sequentially protrude from the opening 111 to intermittently massage the perineum. Therefore, a true massaging effect can be achieved.

In addition, the massaging members 24 are rotary soft wheels. Therefore, the massaging members 24 can massage the perineum with a most suitable force without greatly stimulating the perineum.

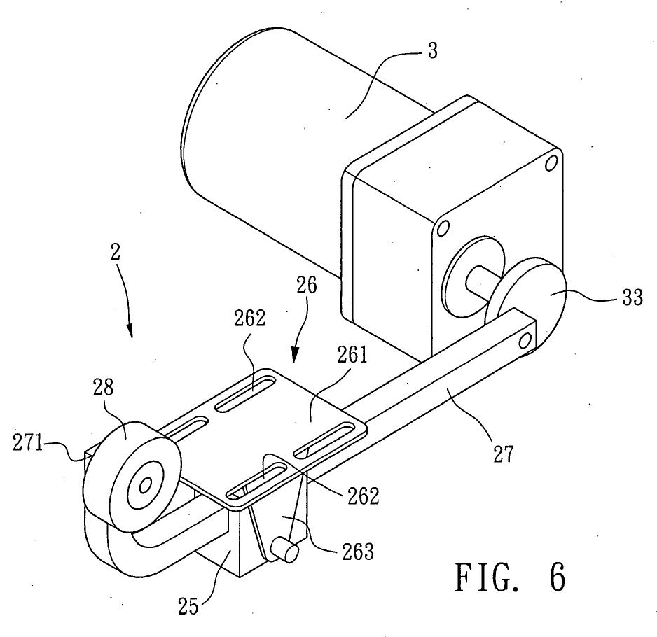

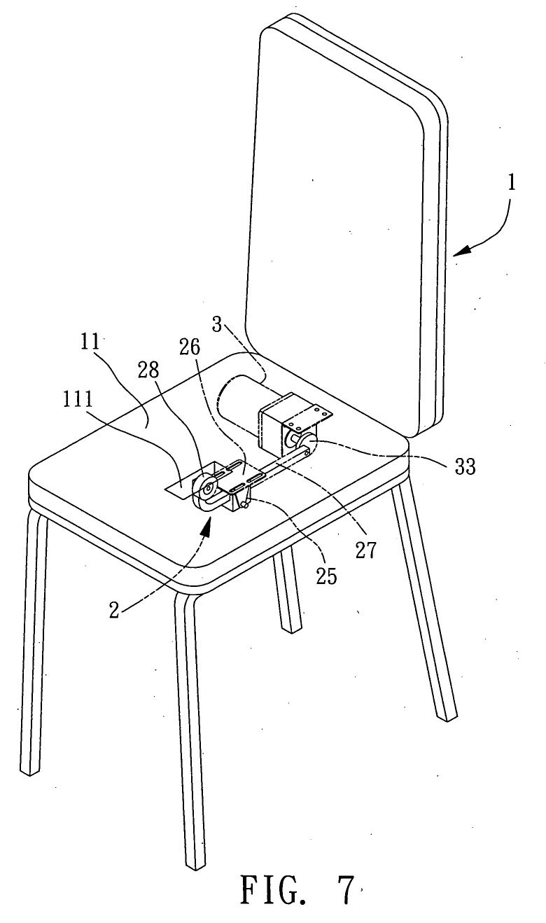

FIGS. 6 and 7 show a second embodiment of the power source and the massaging unit of the present invention, in which the power source 3 is a reducing motor for driving a rotary disc 33 to rotate. The power source 3 is fixed under the supporting face 11 of the support member 1 on one side of the opening 111.

The massaging unit 2 includes a rocking bar 27 positioned under the bottom of the supporting face 11 corresponding to the opening 111. The rocking bar 27 extends through a rocking block 25. The rocking block 25 via a seat body 26 is pivotally disposed under the bottom of the supporting face 11. The seat body 26 has a board body 261 two sides of which are formed with several distance adjustment slots 262. One face of the board body 261 is fixed under the supporting face 11 by screws passing through the distance adjustment slots. The other face of the board body 261 has two downward extending pivot lugs 263. The rocking block 25 is pivotally connected between the two pivot lugs 263. One end of the rocking bar 27 is pivotally connected with a circumference of the rotary disc 33 of the power source 3. The other end of the rocking bar 27 has a pivot end 271 upward extending toward the opening 111. A massaging member 28 is pivotally connected with the pivot end 271 and positioned in the opening 111.

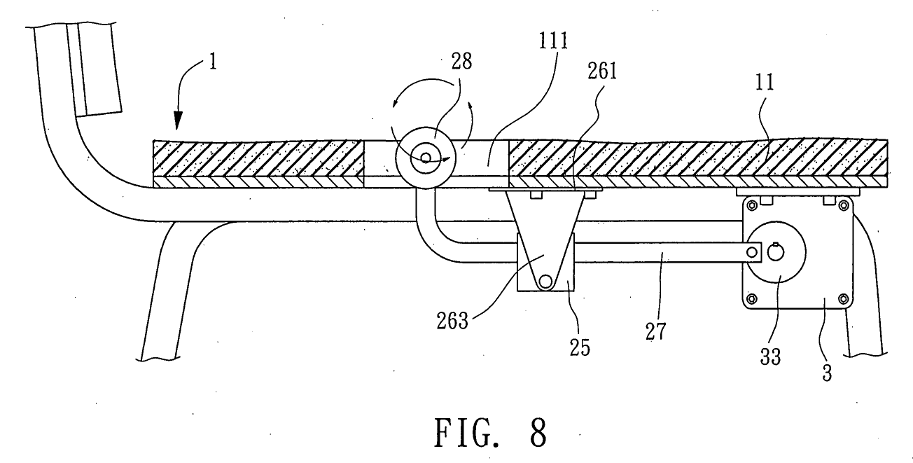

In use, as shown in FIG. 8, the power source 3 is activated to rotate the rotary disc 31 for driving one end of the rocking bar 27 to rotate along with the rotary disc 31. The rocking bar 27 extends through the rocking block 25 which is pivotally connected under the supporting face 11. Therefore, when one end of the rocking bar 27 is rotated along with the rotary disc 31, the massaging member 28 pivotally connected with the pivot end 271 of the rocking bar 27 will revolve up and down and intermittently protrude from the opening 111. Therefore, the massaging member 28 will intermittently massage the perineum of the user to expedite the blood circulation of the perineum and thus improve the functions of the prostate gland.

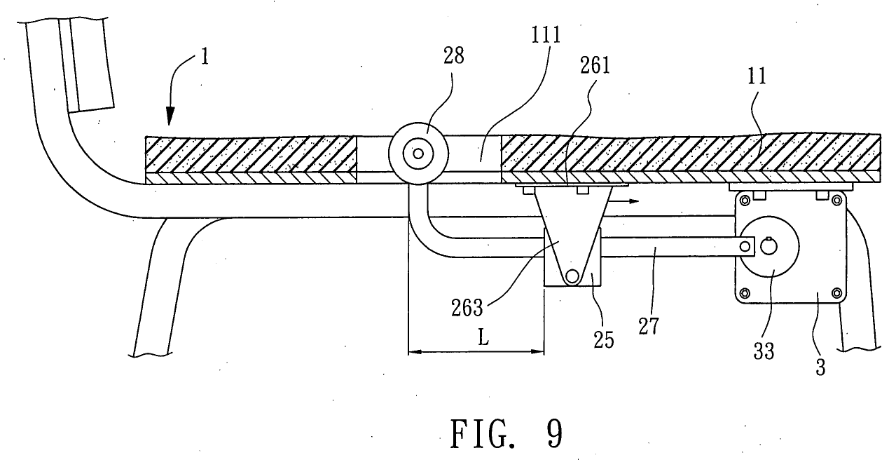

Moreover, by means of adjusting the position of the seat body 26, the revolving travel of the massaging member 28 can be changed so as to adjust the massaging force of the massaging member 28. The rocking bar 27 extends through the rocking block 25 so that by means of adjusting the position of the seat body 26 forward or backward, the length L of the rocking bar 27 between the massaging member 8 and the rocking block 25 can be changed as shown in FIG. 9. Accordingly, the revolving travel of the massaging member 28 can be changed to vary the massaging force applied to the perineum. Therefore, the user can adjust the massaging force to an optimal value according to the sensitivity of the user to the application force.

The above embodiments are only used to illustrate the present invention, not intended to limit the scope thereof. Many modifications of the above embodiments can be made without departing from the spirit of the present invention.

What is claimed is:

1. A massaging device capable of improving functions of prostate gland, comprising a support member having a supporting face for a human body to sit or ride thereon, a massaging unit being disposed in the support member and having at least one massaging member, the massaging unit be driven by a power source to intermittently protrude the massaging member from a surface of the supporting face of the support member so as to intermittently press and massage the perineum of the human body corresponding to the prostate gland.

2. The massaging device as claimed in claim 1, wherein the support member is a chair and the supporting face is a seat of the chair, the supporting face being formed with an opening where the massaging unit is disposed, whereby the massaging member of the massaging unit protrudes from the opening.

3. The massaging device as claimed in claim 2, wherein the massaging unit and the power source are fixed under the supporting face of the support member via a base seat, the base seat having two sidewalls and a fixing plate on upper edges of two first ends of the sidewalls, the fixing plate being fixed under the supporting face of the support member, the power source being disposed one side of one of the sidewalls for driving a driving wheel positioned between the two sidewalls, the driving wheel being connected with a transmission member for driving the massaging unit to rotate, the massaging unit being positioned between two second ends of the sidewalls of the base seat opposite to the fixing plate, the massaging unit including a shaft rod two ends of which are shafted on the sidewalls, a rotary member and a driven wheel being fitted on the shaft rod, the driven wheel being connected with the transmission member of the power source, the rotary member having several massaging members which take turns to protrude from the opening of the surface of the supporting face of the support member.

4. The massaging device as claimed in claim 3, wherein the power source is a reducing motor.

5. The massaging device as claimed in claim 3, wherein the rotary member has three vanes which radially extend at equal angular intervals, each vane being pivotally connected with a massaging member which protrudes from the base seat.

6. The massaging device as claimed in claim 5, wherein the massaging member is a soft wheel body.

7. The massaging device as claimed in claim 2, wherein the power source is fixed under the supporting face of the support member on one side of the opening for driving a rotary disc to rotate, the massaging unit including a rocking bar positioned under the bottom of the supporting face corresponding to the opening, the rocking bar extending through a rocking block, the rocking block being pivotally disposed under the bottom of the supporting face and movable along the length of the opening, one end of the rocking bar being pivotally connected with a circumference of the rotary disc of the power source, the other end of the rocking bar having a pivot end upward extending toward the opening, a massaging member being pivotally connected with the pivot end and positioned in the opening.

8. The massaging device as claimed in claim 7, wherein the rocking block via a seat body is pivotally disposed under the bottom of the supporting face, the seat body having a board body two sides of which are formed with several distance adjustment slots, one face of the board body being fixed under the supporting face by screws passing through the distance adjustment slots, the other face of the board body having two downward extending pivot lugs, the rocking block being pivotally connected between the two pivot lugs.

9. The massaging device as claimed in claim 7, wherein the power source is a reducing motor.

10. The massaging device as claimed in claim 7, wherein the massaging member is a soft wheel body.
